(19) United States
(12) Patent Application Publication
(10) Pub. No.: US 2017/0016514 A1
(43) Pub. Date: Jan. 19, 2017

(54) FIXED GEAR MESH MOTOR PLATE WITH ADJUSTABLE IDLER GEAR

(71) Applicant: ARRMA DURANGO LTD, Ashby-de-la-Zouch (GB)

(72) Inventor: Jami Jones, Measham (GB)

(21) Appl. No.: 14/799,843

(22) Filed: Jul. 15, 2015

(51) Int. Cl. F16H 1/20

(52) U.S. Cl. CPC F16H 1/20

(57) ABSTRACT

An adjustable idler gear assembly comprises an idler gear that meshes with a mating gear and is driven to rotate by a pinion directly or indirectly via at least one intermediate gear, and an idler positioning body having an idler gear shaft with which the idler gear is rotationally coupled. The idler positioning body is configured to change a position of the idler gear shaft along a circular path at a range of distances from an axis of rotation of the pinion to selectively engage and disengage from being driven by the pinion while maintaining a consistent mesh with the mating gear.

### BACKGROUND

Field

The field of the embodiments generally relates to a drive gear mesh for model vehicles, and more particularly to a fixed gear mesh motor plate with an adjustable idler gear.

Related Art

Remote control (RC) model vehicles typically require the ability to adjust gear ratio, either for different usage conditions or to allow differently sized wheels and tires to be fit on the vehicle while maintaining the same overall gear ratio. To change the gear ratio usually involves changing a pinion on a motor shaft, a spur gear driven by the pinion, or both. The dimensional relationship between the pinion and the spur gear is called gear mesh.

The motor is usually fixed either to a chassis or a motor plate at two or more points; one of the points is the pivot and the other(s) can be loosened to move the motor in relation to the spur gear and allow smaller or larger pinions or spur gears to be installed. The downside of this style of fixing the motor and motor plate is that in a high impact situation, the heavy motor can move and affect the gear mesh. Gear mesh that is too tight or too loose can easily destroy the gears or overheat the electronics of the motor's drive system.

### SUMMARY

According to an embodiment, an adjustable idler gear assembly includes an idler gear that meshes with a mating gear and is driven to rotate by a pinion either directly or indirectly via at least one intermediate gear, and an idler positioning body having an idler gear shaft with which the idler gear is rotationally coupled. The idler gear rotates about an axis of rotation coincident with the idler gear shaft. The idler positioning body is configured to change a position of the idler gear shaft along a circular path at a range of distances from an axis of rotation of the pinion to selectively engage and disengage from being driven by the pinion while maintaining a consistent mesh with the mating gear.

The circular path may have a geometric center coincident with an axis of rotation of the mating gear.

The circular path may have a geometric center equidistant between the axis of rotation of the idler gear shaft and an axis of rotation of the mating gear.

The idler gear may be driven to rotate by a different pinion having a different rotational radius at each of a plurality of different positions along the circular path. Each of the different pinions may be alternately disposed in a same pinion operating position and have the same axis of rotation.

The idler gear shaft and coincident axis of rotation may be parallel with the axes of rotation of both the mating gear and the pinion.

The pinion may be driven to rotate about a prime mover shaft by a prime mover, the idler gear may be driven to rotate by the pinion, and the mating gear may be driven to rotate by the idler gear.

The adjustable idler gear assembly may further include a locking fastener that releasably locks the position of the idler positioning body to maintain the idler gear's mesh with the pinion when the idler gear shaft is fixed at a set distance from the axis of rotation of the pinion, and unlocks the position of the idler positioning body to facilitate changing the idler gear shaft's distance from the axis of rotation of the pinion.

The adjustable idler gear assembly may further include a positioning track slidably coupled with the idler positioning body, the positioning track being curved along a circular path having a geometric center coincident with the axis of rotation of the mating gear to slide the idler positioning body along the positioning track while maintaining the idler gear's mesh with the mating gear.

The idler positioning body may be rotationally coupled with a shaft coincident with the axis of rotation of the mating gear, the idler positioning body rotating about the shaft coincident with the axis of rotation of the mating gear to change the position of the idler gear shaft along the circular path.

A position of the idler positioning body may be adjusted via a set screw, screw gear, or a worm gear.

The idler gear may be a compound idler gear having multiple different rotational radii at different positions along the axis of rotation on the same idler gear shaft.

The idler gear may simultaneously mesh with both the pinion and the mating gear.

According to another embodiment, an adjustable idler gear assembly includes an idler gear that simultaneously meshes with a mating gear and a pinion; and an idler positioning body having an idler gear shaft, in which the idler gear is rotationally coupled with the idler gear shaft to rotate about an axis of rotation coincident with the idler gear shaft. The idler positioning body is configured to change a position of the idler gear shaft along a circular path at a changed distance from the pinion and a consistent distance from the mating gear. The circular path has a geometric center coincident with an axis of rotation of the mating gear.

The idler gear may simultaneously meshes with the mating gear and a different pinion having a different rotational radius at each of a plurality of positions along the circular path, each of the different pinions being alternately disposed in a same pinion operating position.

According to another embodiment, a method of adjusting an idler gear in an adjustable idler gear assembly as discussed above includes removing a first pinion from the pinion operating position on a pinion shaft, placing a second pinion having a different rotational radius than the first pinion in the pinion operating position on the pinion shaft, and adjusting a position of the idler gear along the circular path to mesh with the second pinion or the at least one intermediate gear while maintaining idler gear mesh with the mating gear.

The first pinion and the second pinion may each be a portion of a compound pinion gear, and removing the first pinion from the pinion operating position and placing the second pinion in the pinion operating position may include adjusting a position of the compound pinion gear on the pinion shaft without removing the compound pinion gear from the pinion shaft.

Removing the first pinion from the pinion operating position may include removing the first pinion from the pinion shaft, and placing the second pinion in the pinion operating position may include installing the second pinion on the pinion shaft.

The method may further include unlocking a position of the idler positioning body prior to adjusting the position of the idler gear, and locking a position of the idler positioning body after adjusting the position of the idler gear.

The method may further include adjusting the position of the idler gear to increase a distance between the idler gear and the pinion before removing the first pinion from the pinion operating position, and adjusting the position of the idler gear to decrease a distance between the idler gear and the pinion after placing the second pinion in the pinion operating position.

The method may further include sliding the idler positioning body on a curved positioning track along a circular path having a geometric center coincident with the axis of rotation of the mating gear while maintaining the idler gear's mesh with the mating gear.

The method may further include circularly rotating the idler positioning body about a an axis of rotation to change the position of the idler gear shaft along the circular path.

The method may further include rotating a set screw, screw gear, or worm gear to adjusting the idler positioning body.

### BRIEF DESCRIPTION OF THE DRAWINGS

These and/or other aspects will become apparent and more readily appreciated from the following description of the embodiments, taken in conjunction with the accompanying drawings in which:

FIG. 1A is an angled view that illustrates a fixed gear mesh motor plate with adjustable idler gear coupled with a motor and a differential, and in which a standard pinion is mounted on a motor shaft, according to an embodiment.

FIG. 1B is an angled view that illustrates the fixed gear mesh motor plate with the adjustable idler gear of FIG. 1A coupled with the motor and the differential, in which a larger pinion than shown in FIG. 1A is mounted on the motor shaft, and the position of the idler gear is adjusted to compensate for the larger pinion, according to an embodiment.

FIG. 2 is an angled view that illustrates the fixed gear mesh motor plate with adjustable idler gear of FIG. 1A coupled with the motor in isolation from the chassis and differential, according to an embodiment.

FIG. 3 is an exploded view that illustrates components of the fixed gear mesh motor plate with adjustable idler gear of FIGS. 1A, 1B, and 2, according to an embodiment.

FIG. 4A is a front view that illustrates the fixed gear mesh motor plate with adjustable idler gear of FIG. 1A coupled with the motor and the differential, and in which a standard pinion is mounted on a motor shaft, according to an embodiment.

FIG. 4B is a front view that illustrates the fixed gear mesh motor plate with adjustable idler gear of FIG. 1B coupled with the motor and the differential, in which a larger pinion than shown in FIG. 4A is mounted on the motor shaft, and the position of the idler gear is adjusted to compensate for the larger pinion, according to an embodiment.

FIG. 5 is a front view that illustrates the fixed gear mesh motor plate with adjustable idler gear of FIGS. 1A and 4A coupled with the motor in isolation from the chassis and differential, according to an embodiment.

FIG. 6 is a front view that illustrates a fixed gear mesh motor plate with adjustable idler gear including a circular idler positioning body that manually rotates a position of the idler gear to mesh with the pinion, according to an alternative embodiment.

FIG. 7 is a front view that illustrates a fixed gear mesh motor plate with adjustable idler gear including a circular idler positioning body that rotates a position of the idler gear to mesh with the pinion under control of a set screw, according to another alternative embodiment.

FIG. 8 is a front view that illustrates a fixed gear mesh motor plate with adjustable idler gear including an idler positioning body that slides an idler positioning body to position the idler gear to mesh with the pinion under control of a set screw, according to another alternative embodiment.

FIG. 9 is a front view that illustrates a fixed gear mesh motor plate with adjustable idler gear similar to the motor plate illustrated in FIG. 4A, but coupled with an internal combustion engine rather than a motor, according to another alternative embodiment.

FIG. 10 is a flow chart of a method of adjusting an idler gear in an adjustable idler gear assembly, according to an embodiment.

### DETAILED DESCRIPTION

Reference will now be made in detail to embodiments, examples of which are illustrated in the accompanying drawings, wherein like reference numerals refer to the like elements throughout.

Embodiments fix positions of a motor, engine, or other prime mover and a spur gear of a differential or drive axle on a chassis or motor plate to prevent problems of prior systems associated with moving the motor in relation to the spur gear to fit different size pinions or spur gears on a vehicle. Because the positions of a motor, engine, or prime mover and a spur gear of a differential or drive axle are fixed, they do not pivot and the mesh between them are not affected in high impact situations unlike prior systems. In the embodiments, adjustment of gearing and gear mesh relationships is handled by movement of a lightweight adjustable idler gear assembly. The lightweight adjustable idler gear assembly also provides a much larger adjustment range than in prior systems, thereby reducing situations in which it is desirable to change the spur gear to obtain a desired gear ratio. As a result, the location of the spur gear on a motor plate is more secure than in prior systems, further protecting a drivetrain of a vehicle according to the embodiments from damage.

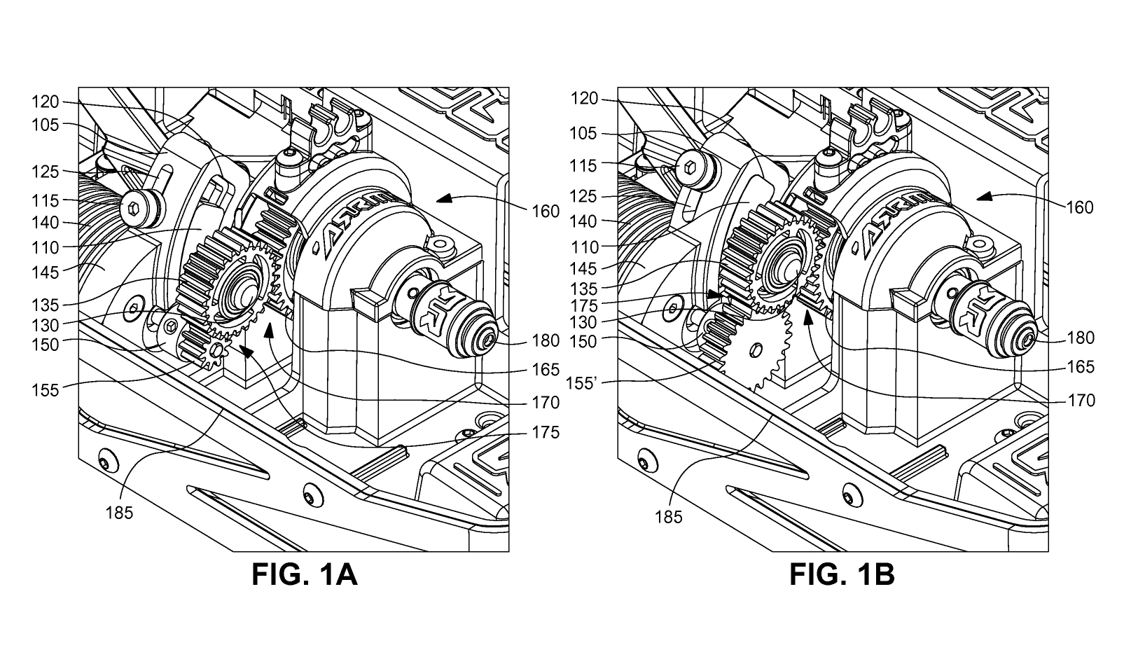

FIG. 1A is an angled view that illustrates a fixed gear mesh motor plate 145 with adjustable idler gear 135 coupled with a motor 140 and a differential 160, and in which a standard pinion 155 is mounted on a motor shaft 150, according to an embodiment. FIG. 1B is an angled view that illustrates the fixed gear mesh motor plate 145 of FIG. 1A with the adjustable idler gear 135 coupled with the motor 140 and the differential 160, in which a larger pinion 155′ than shown in FIG. 1A is mounted on the motor shaft 150, and the position of the idler gear 135 is adjusted to compensate for the larger pinion 155′, according to an embodiment. The motor 140, the differential 160, and the motor plate 145 may all be fastened to a common chassis 185 to hold the motor 140, the differential 160, and the motor plate 145 in fixed position.

The motor 140 may be an electric motor in various embodiments, but this should not be construed as limiting, as the motor 140 may take other forms of prime movers as known in the art in various other embodiments. The motor shaft 150 may also more generally be referred to as a pinion shaft or prime mover shaft. The differential includes a spur gear 165 that mates or meshes with the idler gear 135. The spur gear 165 may be referred to as a mating gear due to its relationship with the idler gear 135. In various embodiments, there may be one or more intermediate gears, including a mating gear that meshes directly with the idler gear 135, between the idler gear 135 and the spur gear 165 of the differential 160 or axle that drives wheels of the vehicle. In various embodiments, one or more intermediate gears may also be present between the pinion 155 and the idler gear 135, or the idler gear 135 may be embodied as a grouping of a plurality of gears meshed together and that together have the function of the idler gear 135 as described herein.

While the differential 160 is described herein as a differential, this should not be construed as limiting. In various embodiments, other devices for accomplishing rotational power transfer to wheels of a vehicle from the spur gear 165 may be used instead of a differential, for example, a basic axle, a differential integrated with a clutch, or the SLIPPERENTIAL™ from RC-MONSTER. Also, in various embodiments, different types of drive gears as known in the art may be used in place of the spur gear 165, and therefore the spur gear 165 may also be referred to more broadly as a drive gear.

The motor 140 may be coupled with the motor plate 145 with one or more fasteners, for example, screws, rivets, bolts, knobs, pins, protrusions, or other fasteners as known in the art. The motor shaft 150 may pass through an opening in the motor plate 145 and facilitate the standard pinion 155, the larger pinion 155′, or other pinions of different rotational radii (not shown) to be alternately fastened to the motor shaft 150. For example, the pinions 155 and 155′ may include a protrusion that seats within a hole in the middle of the end of the motor shaft 150 and may be fastened in place by a set screw on a side of the motor shaft 150 that applies a friction force against the protrusion of the pinions 155 and 155′ to hold the pinions 155 and 155′ in place at the end of the motor shaft 150. In other embodiments, the pinions 155 and 155′ may have a central opening through which a separate pin having a head with an outer diameter greater than a diameter of the central opening may pass, and the pin may also simultaneously pass through the hole in the end of the motor shaft 150 to hold the pinion 155 or 155′ in place when the set screw on the side of the motor shaft 150 applies a friction force against the side of the pin.

The idler gear 135 may be coupled with and rotate about an idler gear shaft 130 that is fastened in place on an idler positioning body 110. The idler positioning body 110 may be slidingly disposed within a positioning track 120 of a sliding idler gear assembly 105 that guides the idler positioning body 110 along a circular curved path that positions the central axis of the idler gear shaft 130 and idler gear 135 at a consistent distance from the central axis of a spur gear 165 and axle 180 while varying a distance between the central axis of the idler gear shaft 130 and idler gear 135 and the central axis of the pinion 155. The position of the idler positioning body 110 within the positioning track 120 may be manually fixed and changed by tightening and loosening of a locking fastener 115 that passes through a fastening slot 125 within the sliding idler gear assembly 105. In various embodiments, the locking fastener 115 may be locked and unlocked by an actuator rather than manually. In various embodiments, the position of the idler positioning body 110 within the positioning track 120 may be changed by an actuator rather than manually.

The idler gear shaft 130 and coincident axis of rotation may be parallel with the axes of rotation of both the spur gear 165 and the pinion 155. The idler gear 135 may have a mesh 170 with the pinion 155 and a mesh 175 with the spur gear 165 that facilitate rotation of the motor shaft 150 and the pinion 155 to cause the idler gear 135 to rotate, which then in turn causes the spur gear 165 to rotate. By loosening the fastener 115 and sliding the idler positioning body 110 along the positioning track 120 away from the pinion 155, the idler gear 135 may be repositioned away from the pinion 155 without changing the mesh 170 between the idler gear 135 and the spur gear 165. Then the pinion 155 can be removed and replaced with the larger pinion 155′, or other pinion of a same or different size as desired, and the new larger pinion 155′ can be fastened to the motor shaft 150 instead of the standard pinion 155. The idler positioning body 110 may then be slid along the positioning track 120 toward the larger pinion 155′ to form the mesh 175 with the new larger pinion 155′ without changing the mesh 170 between the idler gear 135 and the spur gear 165.

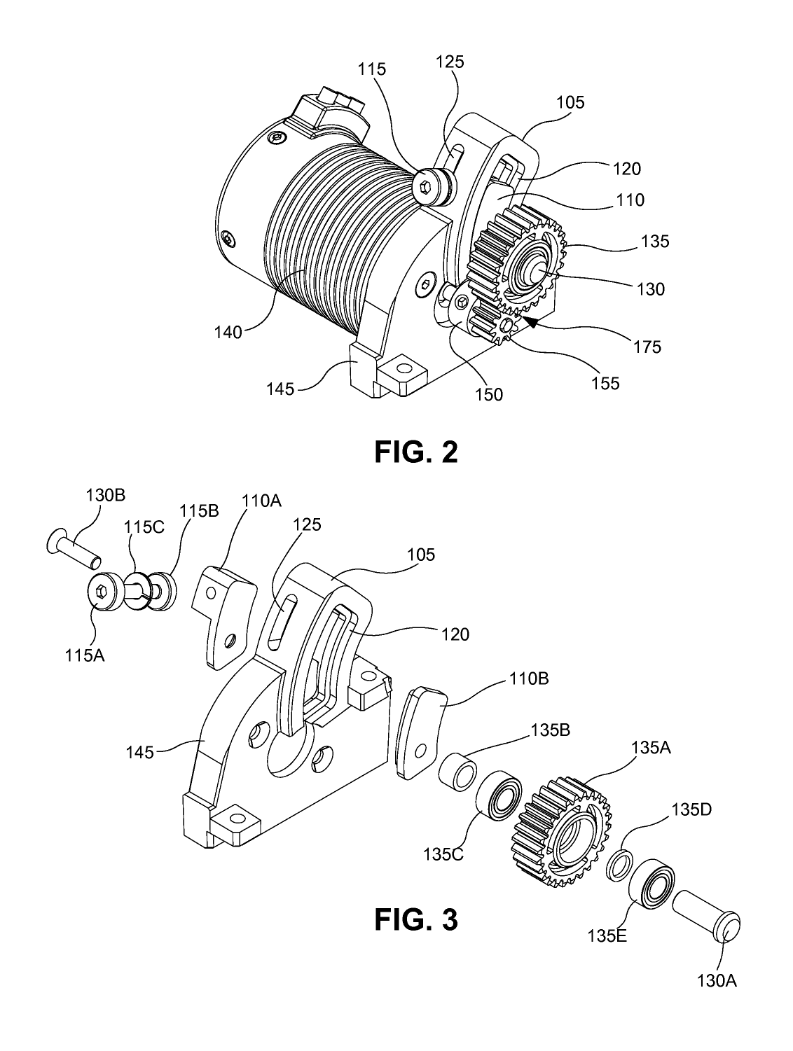

FIG. 2 is an angled view that illustrates the fixed gear mesh motor plate 145 with the adjustable idler gear 135 of FIG. 1A coupled with the motor 140 in isolation from the chassis 185 and the differential 160, according to an embodiment. FIG. 3 is an exploded view that illustrates components of the fixed gear mesh motor plate 145 with the adjustable idler gear 135 of FIGS. 1A, 1B, and 2, according to an embodiment. A locking idler positioning body member 110A and a sliding idler positioning body member 110B may couple together on either side of the positioning track 120 to form the idler positioning body 110 that slides along the positioning track 120. A locking fastener bolt 115A may pass through a locking fastener spacer 115B, a locking fastener washer 115C, and the fastening slot 125 to fasten to the locking idler positioning body member 110A. In various embodiments, different forms of the locking fastener 115 may be utilized to releasably fasten the idler positioning body into position within the fastening slot 125. For example, the locking fastener 115 may include a screw, a bolt, a knob, a pin, a protrusion, or other releasable fasteners as known in the art.

One or both of an idler gear shaft outer pin 130A and idler gear shaft inner pin 130B may pass through each of the idler positioning body 110, an idler gear spacer 135B, an idler gear inner body insert 135C, an idler gear inner body washer 135D, and idler gear outer body insert 135E to hold the idler gear outer body 135A in position on the idler positioning body 110.

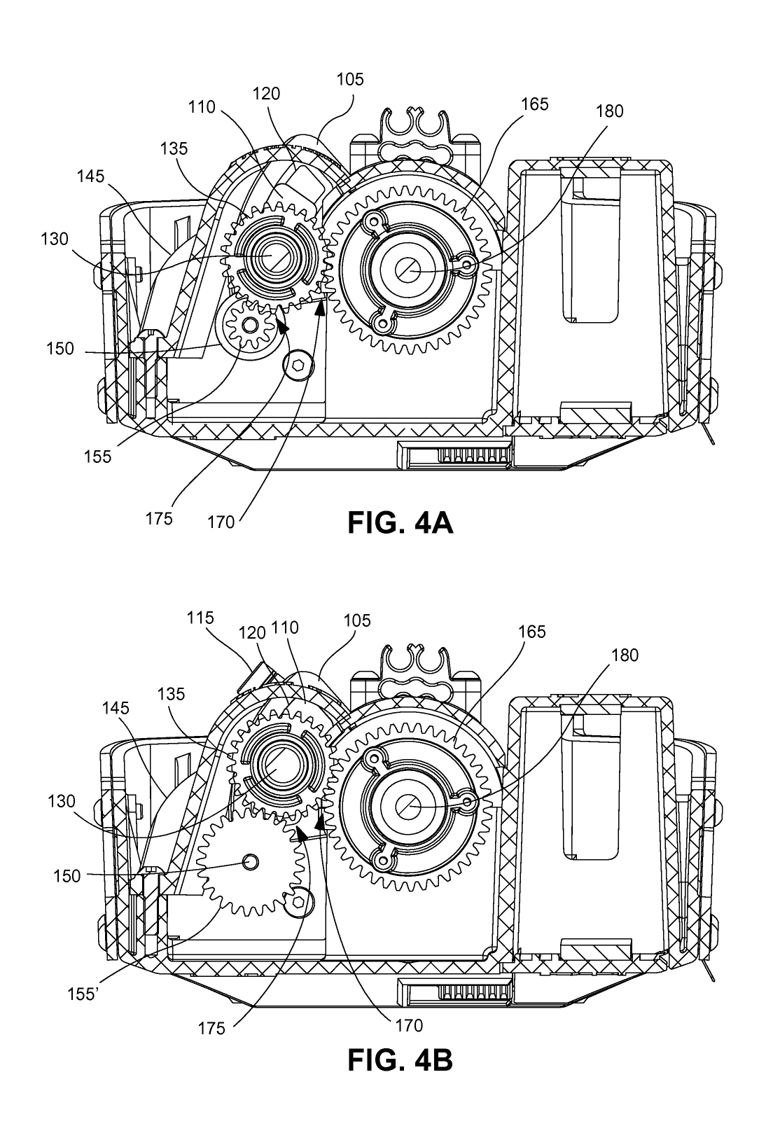

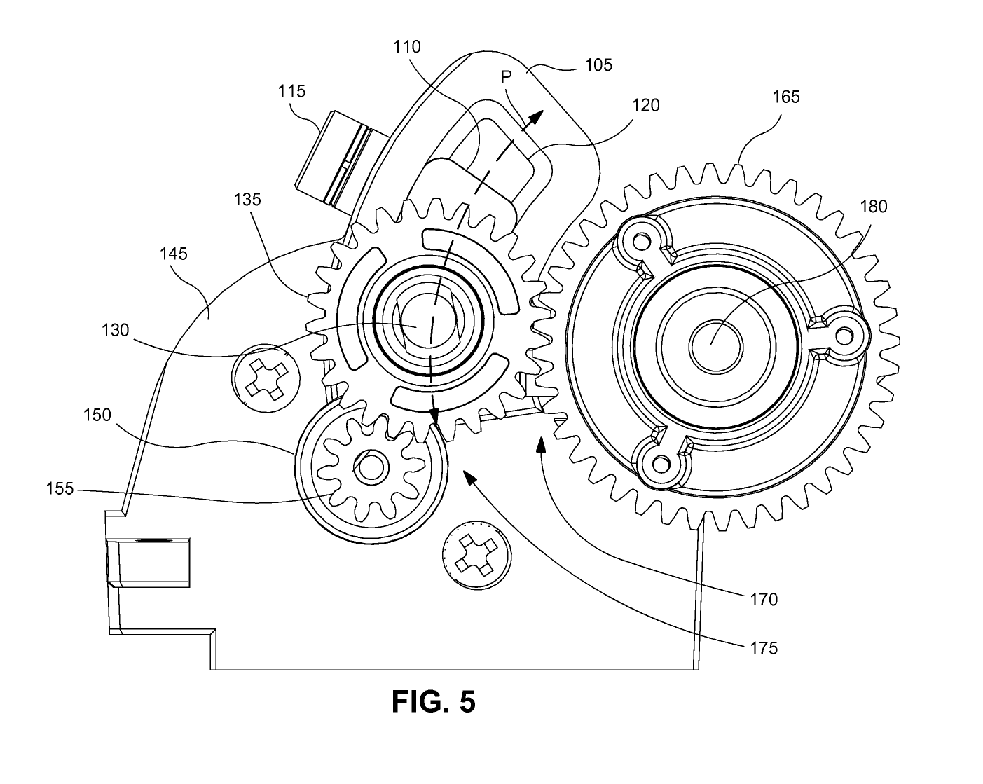

FIG. 4A is a front view that illustrates the fixed gear mesh motor plate 145 with the adjustable idler gear 135 of FIG. 1A coupled with the motor 140 and the differential 160, and in which the standard pinion 155 is mounted on the motor shaft 150, according to an embodiment. FIG. 4B is a front view that illustrates the fixed gear mesh motor plate 145 with the adjustable idler gear 135 of FIG. 1B coupled with the motor 140 and the differential 160, in which a larger pinion 155′ than shown in FIG. 4A is mounted on the motor shaft 150, and the position of the idler gear 135 is adjusted to compensate for the larger pinion 155′, according to an embodiment. FIG. 5 is a front view that illustrates the fixed gear mesh motor plate 145 with the adjustable idler gear 135 of FIGS. 1A and 4A coupled with the motor 140 in isolation from the chassis 185 and the differential 160, according to an embodiment. FIG. 5 illustrates that the idler positioning body 110 slides along a curved path P to reposition the idler gear shaft 130 and idler gear 135 along the curved path P while maintaining a consistent mesh 170 between the idler gear 135 and the spur gear 165. In this embodiment, the curved path P is an arc of a circle that is centered at the axle 180, which is the axis of rotation of the spur gear 165.

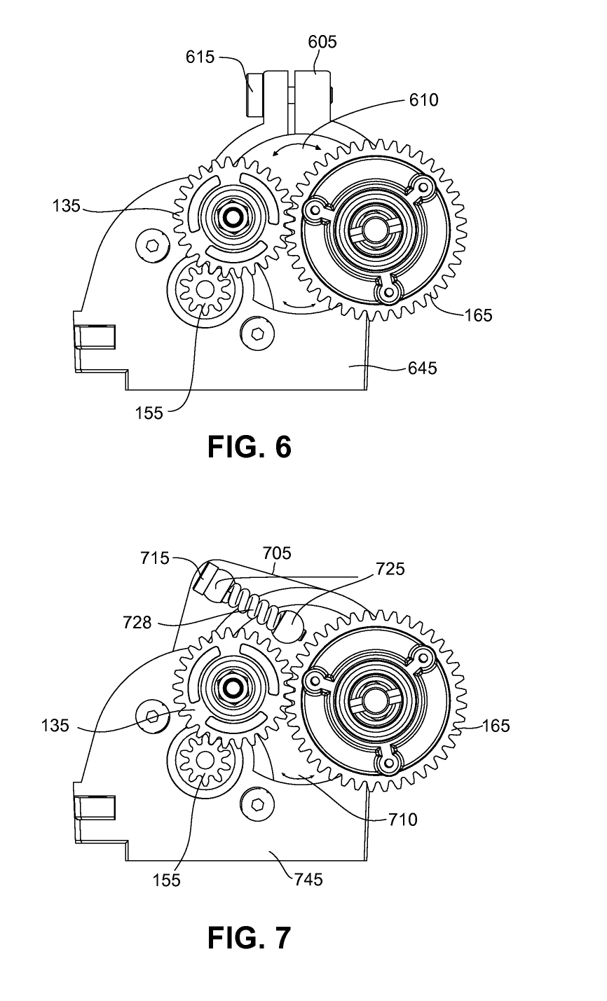

FIG. 6 is a front view that illustrates a fixed gear mesh motor plate 645 with adjustable idler gear 135 including a circular idler positioning body 610 that manually rotates a position of the idler gear 135 to mesh with the pinion 155, according to an alternative embodiment. The circular idler positioning body 610 is included in the motor plate 645 as an alternative to the idler positioning body 110 in the motor plate 145 of FIGS. 1A, 1B, 2, 3, 4A, 4B, and 5. The idler gear 135 may be coupled with and rotate about an idler gear shaft 130 that is fastened in place on the circular idler positioning body 610. The circular idler positioning body 610 may rotate the position of the idler gear 135 along a circular path within a circular mounting location of a clamping circular idler gear mounting assembly 605 to maintain a consistent distance between the central axis of the idler gear 135 and the idler gear shaft 130 and the central axis of the spur gear 165 and the axle 180 while varying a distance between the central axis of the idler gear shaft 130 and the idler gear 135 and the central axis of the pinion 155. The center of rotation of the circular idler positioning body 610 may be equidistant between the axis of rotation of the idler gear 135 and the axis of rotation of the spur gear 165. The spur gear 165 may also be coupled with the circular idler positioning body 610 such that a position of the spur gear 165 may also rotate about the center of rotation of the circular idler positioning body 610.

The position of the circular idler positioning body 610 within the clamping circular idler gear mounting assembly 605 may be manually fixed and changed by tightening and loosening of a locking fastener 615 that passes through openings within the clamping circular idler gear mounting assembly 605 perpendicular to the central axis of the idler gear shaft 130 to alternatively clamp the circular idler positioning body 610 in position to maintain the mesh 175 with the pinion 155 and unclamp the circular idler positioning body 610 to facilitate the circular idler positioning body 610 to rotate and modify the mesh 175 with the pinion 155. In various embodiments, the locking fastener 615 may include a screw, a bolt, a knob, a pin, a protrusion, or other releasable fasteners as known in the art. In various embodiments, the locking fastener 615 may be locked and unlocked by an actuator rather than manually. In various embodiments, the position of the circular idler positioning body 610 may be changed by an actuator rather than manually.

FIG. 7 is a front view that illustrates a fixed gear mesh motor plate 745 with adjustable idler gear 135 including a circular idler positioning body 710 that rotates a position of the idler gear 135 to mesh with the pinion 155 under control of a set screw 715, according to another alternative embodiment. The circular idler positioning body 710 may be an embodiment of the circular idler positioning body 610 of FIG. 6. The circular idler positioning body 710 is included in the motor plate 745 as an alternative to the idler positioning body 110 in the motor plate 145 of FIGS. 1A, 1B, 2, 3, 4A, 4B, and 5. The idler gear 135 may be coupled with and rotate about an idler gear shaft 130 that is fastened in place on the circular idler positioning body 710. The circular idler positioning body 710 may rotate the position of the idler gear 135 along a circular path within a circular mounting location of a set screw adjusting circular idler gear mounting assembly 705 to maintain a consistent distance between the central axis of the idler gear 135 and the idler gear shaft 130 and the central axis of the spur gear 165 and the axle 180 while varying a distance between the central axis of the idler gear shaft 130 and the idler gear 135 and the central axis of the pinion 155. The center of rotation of the circular idler positioning body 710 may be equidistant between the axis of rotation of the idler gear 135 and the axis of rotation of the spur gear 165. The spur gear 165 may also be coupled with the circular idler positioning body 710 such that a position of the spur gear 165 may also rotate about the center of rotation of the circular idler positioning body 710.

The position of the circular idler positioning body 710 within the set screw adjusting circular idler gear mounting assembly 705 may be changed by rotating the set screw 715 that passes through two or more set screw barrels 725 and a tension spring 728. As illustrated in FIG. 7, one set screw barrel 725 is coupled with the set screw adjusting circular idler gear mounting assembly 705, and another set screw barrel 725 is coupled with the circular idler positioning body 710. The tension spring 728 provides tension between the set screw barrels 725 to provide a force that tends to pull the set screw barrels 725 toward each other or push them away from each other. This force of the tension spring 728 assists in maintaining a fixed position of the circular idler positioning body 710 within the set screw adjusting circular idler gear mounting assembly 705 when the mesh 175 between the idler gear 135 and the pinion 155 is not being adjusted. The set screw 715 may be positioned perpendicular to the central axis of the idler gear shaft 130 to rotate the circular idler positioning body 710 to adjust the mesh 175 with the pinion 155. When the set screw 715 is rotated in one direction, the circular idler positioning body 710 may rotate in a clockwise direction relative to the set screw adjusting circular idler gear mounting assembly 705 as illustrated in FIG. 7 to move the central axis of the idler gear 135 and idler gear shaft 130 away from the pinion 155, and when the set screw 715 is rotated in an opposite direction, the circular idler positioning body 710 may rotate in a counter-clockwise direction relative to the set screw adjusting circular idler gear mounting assembly 705 as illustrated in FIG. 7 to move the central axis of the idler gear 135 and idler gear shaft 130 toward the pinion 155 to provide the mesh 175 between the idler gear 135 and the pinion 155. In various embodiments, the set screw 715 may be include a screw, a bolt, a knob, a pin, a protrusion, or other releasable fasteners as known in the art. In various embodiments, a screw gear or a worm gear may be used in place of the set screw 715. In various embodiments, the set screw 715 may be rotated by an actuator rather than manually.

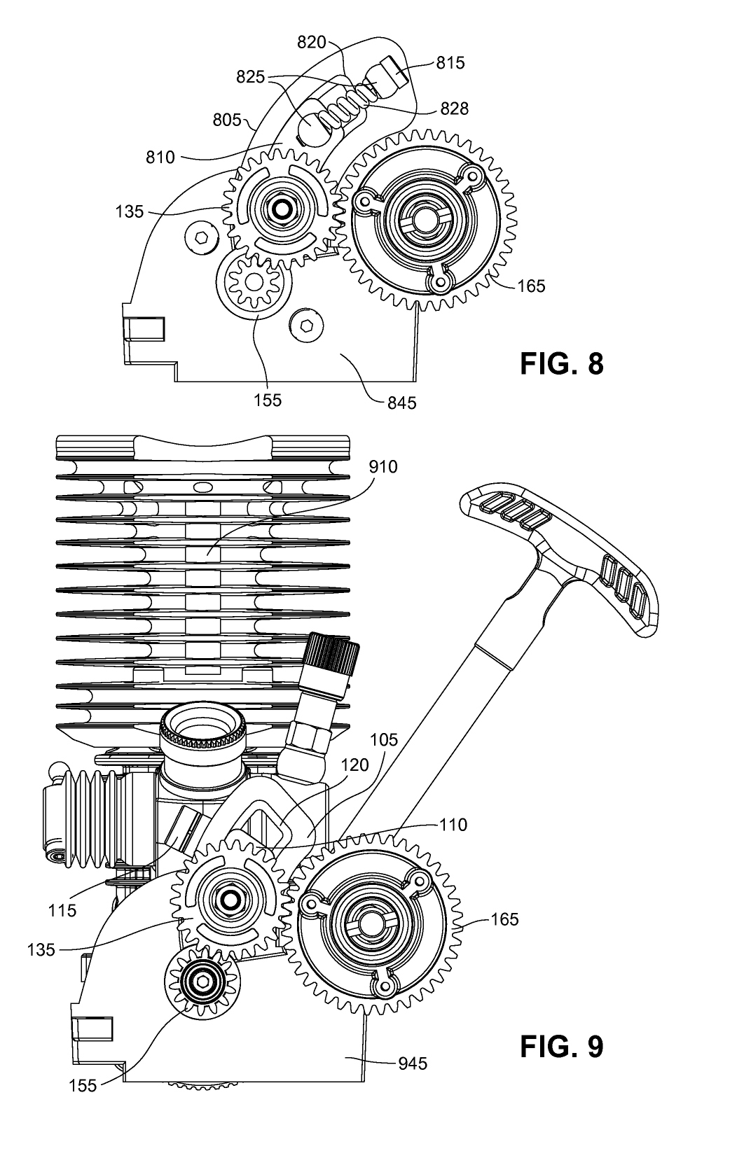

FIG. 8 is a front view that illustrates a fixed gear mesh motor plate 845 with adjustable idler gear 135 including an idler positioning body 810 that slides the idler positioning body 810 to position the idler gear 135 to mesh with the pinion 155 under control of a set screw 815, according to another alternative embodiment. The motor plate 845 may be an embodiment of the motor plate 145, with the difference that the set screw 815 replaces the locking fastener 115. The motor plate 845 includes a sliding idler gear mounting assembly 805 having a positioning track 820 within which the idler positioning body 810 may be slidingly disposed to guide the idler positioning body 810 along a circular curved path that positions the central axis of the idler gear shaft 130 and idler gear 135 at a consistent distance from the central axis of a spur gear 165 and axle 180 while varying a distance between the central axis of the idler gear shaft 130 and idler gear 135 and the central axis of the pinion 155.

The position of the idler positioning body 810 within the sliding idler gear mounting assembly 805 may be changed by rotating the set screw 815 that passes through two or more set screw barrels 825 and a tension spring 828. As illustrated in FIG. 8, one set screw barrel 825 is coupled with the sliding idler gear mounting assembly 805, and another set screw barrel 825 is coupled with the idler positioning body 810. The tension spring 828 provides tension between the set screw barrels 825 to provide a force that tends to pull the set screw barrels 825 toward each other or push them away from each other. This force of the tension spring 828 assists in maintaining a fixed position of the idler positioning body 810 within the sliding idler gear mounting assembly 805 when the mesh 175 between the idler gear 135 and the pinion 155 is not being adjusted. The set screw 815 may be positioned perpendicular to the central axis of the idler gear shaft 130 to slide the idler positioning body 810 within the positioning track 820 to adjust the mesh 175 with the pinion 155. When the set screw 815 is rotated in one direction, the idler positioning body 810 may slide in a clockwise direction relative to the sliding idler gear mounting assembly 805 and spur gear 165 as illustrated in FIG. 8 to move the central axis of the idler gear 135 and idler gear shaft 130 away from the pinion 155, and when the set screw 815 is rotated in an opposite direction, the idler positioning body 810 may slide in a counter-clockwise direction relative to the sliding idler gear mounting assembly 805 and spur gear 165 as illustrated in FIG. 8 to move the central axis of the idler gear 135 and idler gear shaft 130 toward the pinion 155 to provide the mesh 175 between the idler gear 135 and the pinion 155. In various embodiments, the set screw 815 may be include a screw, a bolt, a knob, a pin, a protrusion, or other releasable fasteners as known in the art. In various embodiments, a screw gear or a worm gear may be used in place of the set screw 815. In various embodiments, the set screw 815 may be rotated by an actuator rather than manually.

FIG. 9 is a front view that illustrates a fixed gear mesh motor plate 945 with adjustable idler gear 135 similar to the motor plate 145 illustrated in FIG. 4A, but coupled with an internal combustion engine 910 rather than a motor 140, according to another alternative embodiment. In various embodiments, any of the motor plates 645, 745, 845, and 945 may also be coupled with an internal combustion engine similar to the internal combustion engine 910 of the embodiment of FIG. 9 rather than the motor 140.

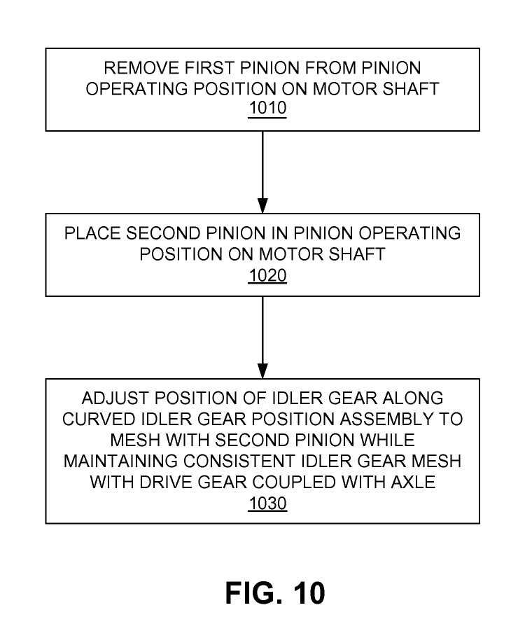

FIG. 10 is a flow chart of a method of adjusting an idler gear in a curved idler gear position assembly, according to an embodiment. The idler gear may be an embodiment of the idler gear 135, and the curved idler gear position assembly may be an adjustable idler gear assembly that includes embodiments of the sliding idler gear assembly 105, clamping circular idler gear mounting assembly 605, set screw adjusting circular idler gear mounting assembly 705, and sliding idler gear mounting assembly 805 illustrated in FIG. 1A, 1B, 2, 3, 4, 5, 6, 7, 8, or 9, or other embodiments having various combinations of features disclosed herein. The idler gear may be mounted on the curved idler gear position assembly, mesh with a mating gear, and be driven to rotate by a pinion either directly or indirectly via at least one intermediate gear. The curved idler gear position assembly may also include an idler positioning body having an idler gear shaft mounted thereon. The idler gear may be rotationally coupled with the idler gear shaft to rotate about an axis of rotation coincident with the idler gear shaft. The idler positioning body may be configured to change a position of the idler gear shaft along a circular path having a geometric center coincident with an axis of rotation of the mating gear to selectively engage and disengage from being driven by the pinion. The idler gear simultaneously maintains a consistent mesh with the mating gear while being repositioned along the circular path, and also while being driven to rotate by a different pinion having a different rotational radius at each of a plurality of positions along the circular path. In other words, the mesh between the idler gear and the mating gear is consistent among all the plurality of positions of the idler gear and idler gear shaft along the circular path having a geometric center coincident with the axis of rotation of the mating gear, and the idler gear meshes with the mating gear simultaneously while being driven to rotate by the pinion, regardless of what radius pinion is installed on the motor shaft and at which of the plurality of positions the idler gear is located when driven by the pinion. Furthermore, the mesh between the idler gear and the mating gear may be consistent during repositioning of the idler gear along the circular path having a geometric center coincident with the axis of rotation of the mating gear.

In various embodiments, the mating gear may be the spur gear of a differential or axle that drives wheels of a vehicle, and may also be referred to as the drive gear. In other embodiments, the mating gear may be another intermediate gear in addition to the idler gear that transfers rotational movement from the pinion to the spur gear of the differential or axle that drives wheels of a vehicle.

Each of a plurality of different pinions with different radii may be alternately disposed in a same operating position relative to the axis of rotation of the mating gear by being mounted on the motor shaft. In this way, the gear ratio between the motor shaft and the mating gear and/or the spur gear of the differential or axle that drives wheels of a vehicle may be adjusted in a convenient and straightforward manner without requiring a distance or positional relationship between the motor shaft and the spur gear of the differential or axle that drives wheels of a vehicle be modified. Thus, the motor and the differential or axle that drives wheels of the vehicle may both be solidly mounted on a same chassis without the possibility of unintended movement during movement of the vehicle in which the chassis is mounted.

At a step 1010, a first pinion is removed from the pinion operating position on a motor shaft. The motor shaft may also be referred to as a pinion shaft. The idler positioning body may first be moved along the circular path away from the first pinion in order to increase a distance between the idler gear and the pinion and unmesh the idler gear from the pinion or intermediate gear prior to removing the pinion from the pinion operating position. The pinion may be removed from the pinion operating position by removing the pinion from a shaft that couples the pinion with a motor, engine, or other prime mover to cause the pinion to rotate. Prior to moving the idler positioning body along the circular path, a position of the idler positioning body may be unlocked.

At a step 1020, a second pinion may be placed in the pinion operating position on the pinion shaft. The second pinion may have a different radius than the first pinion. The second pinion may be placed in the pinion operating position by mounting the pinion on the shaft that couples the pinion with the motor, engine, or other prime mover to cause the pinion to rotate. After the second pinion is placed in the pinion operating position on the pinion shaft, the position of the second pinion may be locked into place.

At a step 1030, a position of the idler gear is adjusted along the circular path to mesh with the second pinion while maintaining idler gear mesh with the mating gear. In some embodiments, the mating gear is a drive gear or a spur gear coupled with an axle. The position of the idler gear may be adjusted along the curved idler gear position assembly by moving the idler positioning body along the circular path toward the second pinion to decrease a distance between the idler gear and the second pinion and mesh the idler gear with the second pinion or intermediate gear. The mesh between the idler gear and the mating gear may be consistent during the adjustment of the position of the idler gear along the circular path. Adjusting the position of the idler gear may include sliding the idler positioning body on a curved positioning track along the circular path having a geometric center coincident with the axis of rotation of the mating gear while maintaining the idler gear's mesh with the mating gear. Alternatively, adjusting the position of the idler gear may include circularly rotating the idler positioning body about a shaft coincident with the axis of rotation of the mating gear to alternately position the idler gear shaft at the plurality of positions along the circular path. In various embodiments, adjusting the idler positioning body may include rotating a set screw, screw gear, or worm gear, either manually or by an actuator.

In various embodiments, the first pinion and the second pinion may each be a portion of a compound pinion gear. For example, the first pinion may be removed from a pinion operating position and the second pinion may be placed in the pinion operating position by moving the compound pinion gear toward or away from the motor plate along the length of the motor shaft to de-align the first pinion and the idler gear or intermediate gear along a plane and align the second pinion with the idler gear or intermediate gear along the same plane. Thus, removing the first pinion from the pinion operating position and placing the second pinion in the pinion operating position may include adjusting a position of the compound pinion gear on the pinion shaft without removing the compound pinion gear from the pinion shaft.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. Descriptions of features or aspects within each embodiment should typically be considered as available for other similar features or aspects in other embodiments unless stated otherwise. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. An adjustable idler gear assembly comprising:
an idler gear that meshes with a mating gear and is driven to rotate by a pinion either directly or indirectly via at least one intermediate gear; and
an idler positioning body having an idler gear shaft, the idler gear rotationally coupled with the idler gear shaft to rotate about an axis of rotation coincident with the idler gear shaft, the idler positioning body configured to change a position of the idler gear shaft along a circular path at a range of distances from an axis of rotation of the pinion to selectively engage and disengage from being driven by the pinion while maintaining a consistent mesh with the mating gear.

2. The adjustable idler gear assembly of claim 1, wherein the circular path has a geometric center coincident with an axis of rotation of the mating gear.

3. The adjustable idler gear assembly of claim 1, wherein the circular path has a geometric center equidistant between the axis of rotation of the idler gear shaft and an axis of rotation of the mating gear.

4. The adjustable idler gear assembly of claim 1, wherein the idler gear is driven to rotate by a different pinion having a different rotational radius at each of a plurality of different positions along the circular path, each of the different pinions being alternately disposed in a same pinion operating position and having the same axis of rotation.

5. The adjustable idler gear assembly of claim 1, wherein the pinion is driven to rotate about a prime mover shaft by a prime mover, the idler gear is driven to rotate by the pinion, and the mating gear is driven to rotate by the idler gear.

6. The adjustable idler gear assembly of claim 1, further comprising a positioning track slidably coupled with the idler positioning body, the positioning track being curved along a circular path having a geometric center coincident with the axis of rotation of the mating gear to slide the idler positioning body along the positioning track while maintaining the idler gear's mesh with the mating gear.

7. The adjustable idler gear assembly of claim 6, wherein a position of the idler positioning body is adjusted via a screw gear or a worm gear.

8. The adjustable idler gear assembly of claim 1, wherein the idler positioning body is rotationally coupled with a shaft coincident with the axis of rotation of the mating gear, the idler positioning body rotating about the shaft coincident with the axis of rotation of the mating gear to change the position the idler gear shaft along the circular path.

9. The adjustable idler gear assembly of claim 8, wherein a position of the idler positioning body is adjusted via a set screw, screw gear, or a worm gear.

10. The adjustable idler gear assembly of claim 1, wherein the idler gear is a compound idler gear having multiple different rotational radii at different positions along the axis of rotation on the same idler gear shaft.

11. An adjustable idler gear assembly comprising:
an idler gear that simultaneously meshes with a mating gear and a pinion; and
an idler positioning body having an idler gear shaft, the idler gear rotationally coupled with the idler gear shaft to rotate about an axis of rotation coincident with the idler gear shaft, the idler positioning body configured to change a position of the idler gear shaft along a circular path at a changed distance from the pinion and a consistent distance from the mating gear, the circular path having a geometric center coincident with an axis of rotation of the mating gear.

12. A method of adjusting an idler gear in an adjustable idler gear assembly comprising an idler gear that meshes with a mating gear and is driven to rotate by a pinion either directly or indirectly via at least one intermediate gear, and an idler positioning body having an idler gear shaft, the idler gear rotationally coupled with the idler gear shaft to rotate about an axis of rotation coincident with the idler gear shaft, the idler positioning body configured to change a position the idler gear shaft along a circular path at a range of distances from an axis of rotation of the pinion to selectively engage and disengage from being driven by the pinion while maintaining a consistent mesh with the mating gear, the method comprising:
removing a first pinion from the pinion operating position on a pinion shaft;
placing a second pinion having a different rotation radius than the first pinion in the pinion operating position on the pinion shaft; and
adjusting a position of the idler gear along the circular path to mesh with the second pinion or the at least one intermediate gear while maintaining idler gear mesh with the mating gear.

13. The method of claim 12, wherein:
the first pinion and the second pinion are each a portion of a compound pinion gear, and
removing the first pinion from the pinion operating position and placing the second pinion in the pinion operating position comprise adjusting a position of the compound pinion gear on the pinion shaft without physically removing the compound pinion gear from the pinion shaft.

14. The method of claim 12, wherein:
removing the first pinion from the pinion operating position comprises removing the first pinion from the pinion shaft, and
placing the second pinion in the pinion operating position comprises installing the second pinion on the pinion shaft.

15. The method of claim 12, further comprising:
unlocking a position of the idler positioning body prior to adjusting the position of the idler gear, and
locking a position of the idler positioning body after adjusting the position of the idler gear.

16. The method of claim 12, further comprising:
adjusting the position of the idler gear to increase a distance between the idler gear and the pinion before removing the first pinion from the pinion operating position, and
adjusting the position of the idler gear to decrease a distance between the idler gear and the pinion after placing the second pinion in the pinion operating position.

17. The method of claim 12, further comprising sliding the idler positioning body on a curved positioning track along a circular path having a geometric center coincident with the axis of rotation of the mating gear while maintaining the idler gear's mesh with the mating gear.

18. The method of claim 12, further comprising circularly rotating the idler positioning body about an axis of rotation to change the position of the idler gear shaft along the circular path.

19. The method of claim 18, further comprising rotating a set screw, screw gear, or worm gear to adjust the idler positioning body.

20. The method of claim 12, further comprising rotating a set screw, screw gear, or worm gear to adjust the idler positioning body.
